(19) United States
(12) Patent Application Publication
(10) Pub. No.: US 2013/0038880 A1
(43) Pub. Date: Feb. 14, 2013

(54) INTERROGATION OF WAVELENGTH-SPECIFIC DEVICES

(71) Applicant: Kieran O'Mahoney, Waterford (IE)

(72) Inventor: Kieran O'Mahoney, Waterford (IE)

(73) Assignee: Waterford Institute of Technology, Waterford (IE)

(21) Appl. No.: 13/518,018

(22) PCT Filed: Dec. 21, 2010
(86) PCT No.: PCT/EP2010/070436

§ 371 Date: Jul. 24, 2012

(30) Foreign Application Priority Data
Dec. 21, 2009 (IE) S2009/0960

(51) Int. Cl. G01J 3/45

(52) U.S. Cl. 356/451

(57) ABSTRACT

An apparatus for interrogating wavelength-specific devices has a broadband optical source to illuminate an interferometer which provides a low coherence temporal interferogram. At least one array of wavelength-specific devices, such as fiber Bragg gratings connected in series with one another, receives the interferogram, so that each device interacts with a limited range of wavelength bandwidth relative to the bandwidth of the broadband optical source. Instead of illuminating an interferometer with the output of an array of devices which have each interacted with a broadband light source at their own characteristic wavelengths, therefore, an interferometer is used to modulate the output from a broadband source to produce a low coherence interferogram. The array of devices then extracts or filters a higher coherence interferogram from this low coherence interferogram.

### TECHNICAL FIELD

This invention relates to the interrogation of wavelength-specific devices.

### BACKGROUND ART

Wavelength-specific filters/reflectors/interferometers have been reported in a variety of telecommunications/sensing applications. One example of their application is in metrology where physical, chemical or biological changes experienced by a device cause a response measurable as a change in the properties of the field propagating through/reflected by the device.

In the optical field, a particular type of wavelength-specific filter/reflector is a fiber Bragg grating (FBG). A fiber Bragg grating reflects a narrow band of wavelengths centred at the Bragg wavelength of the grating (a periodic refractive index modulation within a length of fiber). When embedded in a structure, such as a bridge, strains transmitted from the structure to the fiber cause the grating to be stretched or compressed, with a resultant shift in the characteristic reflected wavelength. Such sensors are also temperature dependent and therefore can be used to monitor for temperature changes also.

Fiber Bragg gratings are used in a variety of capacities in telecommunications. They are used as notch filters and for multiplexing/demultiplexing and add/drop multiplexing. These applications generally use an optical circulator in conjunction with the grating to filter out or add wavelength specific channels.

They are also used for compensation of chromatic dispersion. Conventionally a length of dispersion compensating fiber would have been used. This length of fiber would have a dispersion coefficient which is the opposite of the single mode fiber used for the actual transport. However, this method increases the transmission loss as well as limiting the optical powers which can be launched into the fiber because of non-linear effects.

Dispersion compensation utilizing FBGs is generally achieved by using a chirped grating to introduce a wavelength specific time delay.

When interrogating or characterising FBGs, variations induced in the reflected wavelength require precise measurement. An ideal interrogation system requires high-resolution, typically ranging from sub-picometer to a few picometers wavelength resolution, and should be capable of interrogating multiplexed gratings, particularly as the gratings are ideally suited to wavelength division multiplexing (WDM).

Low coherence interferometry (LCI) has been identified as a key technology platform in a wide range of areas, including fiber-optic communications, metrology, security, aerospace, gas and oil industry, civil and geotechnical engineering and environmental monitoring.

Interferometric spectroscopy, typically implemented as Fourier transform spectroscopy (FTS) exhibits a fundamental advantage over competing techniques because the full wavelength range is characterised within the captured interferogram. This advantage is known as the Fellgett advantage, or multiplex advantage.

However, conventional implementation of FTS using interferometric means relies on the illumination of the interferometer by the light to be interrogated and is therefore not suitable for simultaneous interrogation of multiple arrays.

The development of supercontinuum broadband sources releases the potential for serial multiplexing of wavelength-specific devices over far greater wavelength ranges than previously reported. Many interrogation techniques have been demonstrated, such as: a drift compensated wavelength shift detection system, a frequency modulated laser diode, a dual interferometric cavity system, interrogation by optical spectrometer, interrogation using matched sensor and receiver pairs and a fiber Fourier transform spectrometer. These and other established techniques, including tuneable laser, tuneable filters and diode arrays, are limited in their ability to cope with one or more of the following:
Interrogation over broad wavelength ranges
Provision of simultaneous measurement of all the gratings in an array
Provision of simultaneous measurement of all the gratings in multiple arrays

They are also limited in their provision of high-resolution measurement of the structural detail of the individual devices which could be potentially valuable in the detection of non-uniform measurand fields.

It is known to place an array of wavelength-specific devices in series along a length of fiber, with each device being constructed to reflect, transmit or filter a different characteristic band of wavelengths. When such an array is illuminated by a broadband light source, each device reflects/transmits/filters at a different wavelength. By feeding the returned light into an interferometer, a temporally scanned interferogram can be produced, which may then be analysed using e.g. Fourier analysis to determine the wavelength returned by each of the devices. This allows each device in the array to be monitored simultaneously.

A problem with this approach is that the devices in the array cannot have overlapping wavelength bandwidths. Therefore, given the spectral bandwidth reflected from each device, signal separation considerations impose a maximum on the number of devices which can be incorporated in an array. In order to exceed this limit, multiple interferometers would be required, each analysing the reflected signal from a respective array of devices.

### DISCLOSURE OF THE INVENTION

The invention provides an apparatus for interrogating wavelength-specific devices, the apparatus comprising:
a broadband optical source for providing a broadband light signal;
an interferometer for receiving said broadband light signal and for providing at an output thereof a low coherence temporal interferogram;
at least one array of wavelength-specific devices connected in series with one another for receiving said interferogram from said output, wherein each device interacts with a limited range of wavelength bandwidth relative to the bandwidth of the broadband optical source;
a detector for receiving light from said at least one array of wavelength-specific devices following interaction with the array;
a spectrum analyser adapted to determine from said received light the signal characteristics associated with said interaction with the devices in said at least one array.

Instead of illuminating an interferometer with the output of an array of devices which have each interacted with a broadband light source at their own characteristic wavelengths, therefore, an interferometer is used to modulate the output from a broadband source to produce a low coherence interferogram. The array of devices then extracts or filters a higher coherence interferogram from this low coherence interferogram, where the frequency of fringes depends on the wavelength of light returned by the device.

The term “broadband source” as used herein denotes a source having a bandwidth in wavelength terms of 20 nm or more, or more preferably 40 nm or more, most preferably 80 nm or more. Typically, the bandwidth will be greater for infrared sources (where a typical bandwidth may be about 100 nm) than for visible sources, which may have bandwidths of bout 30-60 nm. In all cases, the bandwidth is much greater than a narrowband laser. The term “low coherence interferogram” is to be construed accordingly, i.e. an interferogram resulting from scanning an interferometer through the bandwidth of the broadband source of at least 20 nm.

Currently available detector technologies integrate over broad wavelength ranges, resulting in the low coherence interferograms observed at the output of a temporally scanned interferometer when illuminated with a broadband source. Optical filters/reflectors, such as the fiber Bragg grating, do not integrate over such broad wavelengths ranges, and are therefore capable of filtering the oscillating component due to their own discrete wavelength bandwidth and transmitting/reflecting this discrete component to the detector. The detector therefore receives for analysis a superposition of high coherence interferograms, each resulting from an individual one of the devices in the array.

Preferably, a plurality of said arrays of wavelength-specific devices are provided, each array receiving the interferogram from said output in parallel, and a plurality of detectors being provided, such that the light from each array is directed to a different detector.

In one embodiment the devices are wavelength-specific reflectors connected in series, which each reflect a narrow band of wavelengths while allowing wavelengths outside this band to pass through.

In another embodiment, the devices are wavelength-specific filters connected in series, which each intercept and filter out a first set of wavelengths while allowing wavelengths outside this set to pass through. The signal may be looped back to the detector by a different route (e.g. by extension of a fiber from the series of devices to the detector.

By illuminating the devices with the interferometer output, rather than the typical illumination of the interferometer with the device output, the restriction on interrogation of a single array using Fourier Transform Spectroscopy, and/or the associated Hilbert transform spectroscopic technique, is removed. This allows for simultaneous interrogation of all of the devices in multiple arrays if illuminated. Also removed is the requirement for devices to reflect/filter at unique wavelengths, as devices reflecting or filtering the same wavelengths can be separated by simply being placed in individual arrays (or lengths of fiber). The only restriction on the wavelength range of the multiple arrays is that of the broadband source illuminating the interferometer (˜1800 nm bandwidths are available using supercontinuum sources).

Preferably, therefore, at least two of said arrays each contain a wavelength specific device which interact with light at the same wavelength.

In a preferred embodiment, the plurality of arrays are connected to said interferometer output by a series of couplers each of which transmits a first proportion of the received interferogram to an associated one of said arrays and transmits a second proportion of the received interferogram to a subsequent one of said couplers.

The couplers are preferably directional couplers, but beam splitters can be used if preferred.

In this way, the low coherence interferogram is successively divided by each directional coupler (DC) so that a proportion of the power illuminates an array coupled to that coupler and the remainder is passed to the next DC in the arrangement.

Preferably, a plurality of isolators is provided for preventing back-propagation of signals from the arrays towards the interferometer and the previous array's detection system.

In a preferred embodiment the first proportion represents from 1 to 20% of the received power at the directional coupler, and the second proportion represents from 80 to 99% of the received power at the directional coupler.

More preferably, the first proportion is from 2 to 10% (the second proportion being from 90 to 98%), yet more preferably, from 3 to 8% (the second proportion being from 92 to 97%), and most preferably about 5% (the second proportion being about 95%). It is to be noted that the first and second proportions are calculated to exclude any insertion loss or back reflections from the DC itself, so that the sum of the first and second proportions in each case represent the usable power and therefore total 100%.

Preferably, a reference device is provided to receive and interact with said interferogram, said reference device being connected to a detector such that the interferogram may be calibrated by reference to the response of the reference device.

The reference device, e.g. a reference Bragg grating serves two purposes. The first is for calibration of the delay in the interferometer by providing a fixed frequency reference from which the non-uniform scan velocity of the fiber stretcher may be corrected. This is beneficial as non-uniform scanning velocity results in non-uniform delay sampling (ideally all beams need to be sampled at the same point in the delay scan otherwise a broadening effect is introduced into the correlation peaks). If this is not calibrated for, the spectral peaks due to closely spaced sensors cannot be readily discriminated. The correction is carried out entirely in software and eliminates the requirement for zero-crossing detection circuits or phase locked loop control of the scan velocity.

The second function is to provide a fixed wavelength reference with which to determine the changing wavelengths of the sensor gratings. If this is not provided, subsequent scan speeds would have to be identical (difficult to achieve) in order to have the same frequency fringes, otherwise the spectra would move position with each scan and this would be seen as a temperature or strain change.

Preferably, said spectrum analyser comprises a processor programmed to perform a mathematical analysis on the detected signal.

The mathematical analysis is preferably a Fourier transform.

The Fourier transform (or any variants such as the Fast Fourier Transform) take a temporally varying signal and convert it to the frequency domain, such that the composite reflected signal is represented as a sum of signals at different frequencies, each of which can be attributed to a different one of the reflectors.

Preferably, where multiple arrays are used, each array's signal is passed via a different channel for signal analysis. One way of doing this is to employ a data acquisition card with multiple channels.

Preferably, said spectrum analyser comprises the same or a different processor programmed to perform a Hilbert transform on the detected signal to calibrate for spectral content associated with temporal scanning of the interferometer.

The Hilbert transform technique calibrates the delay in the interferometer, removing unwanted spectral content introduced in the Fourier transform by the non-uniform scanning velocity of mechanical translation. The temporal phase vector obtained via the Hilbert transform can also provide high-resolution measurement of the mean wavelength reflected/transmitted in the case where high speed scanning is required. If high speed scanning is not an issue, Fourier transform spectroscopy can be used to provide intra-device spectral detail when long scans are taken. The Hilbert transform processing technique eliminates the requirement for sophisticated delay tracking electronics as all processing is conducted entirely in software.

Existing interferometric Fourier transform spectroscopic analysis requires long scans to provide high-resolution measurement. The relationship between the minimum resolvable wavelength change, δλ, and the scan length, τ_{Δ}, is

$$δ λ = {n}_{a} \frac{{λ}^{2}}{c {τ}_{Δ}}$$

where nₐ is the group index of air, λ is the wavelength of the light, c is the speed of light in a vacuum. Therefore a 300 mm scan will give an approximate resolution of 10 pm (using 1550 nm light), allowing a strain change of 10με (10 microstrain) or a temperature change of ˜1° C. to be determined. However, using Hilbert Transform Processing (which this unit uses), a resolution of ˜5 pm can be obtained from a ˜1 mm scan.

The use of the Hilbert transform processing technique, also removes the requirement for delay tracking circuits to compensate for non-uniform sampling of the interferometric delay (due to non-uniform scanning velocity), which has the effect of broadening the correlation peaks.

In one preferred embodiment, the wavelength-specific devices are fiber Bragg gratings.

Preferably, each device within an array is responsive to light in a different range of wavelengths.

There is also provided a method of interrogating wavelength-specific devices, comprising the steps of:
generating a low coherence temporal interferogram from an interferometer illuminated with a broadband optical source;
providing said interferogram to an input of at least one array of wavelength-specific devices connected in series with one another, wherein each device interacts with a limited range of wavelength bandwidth relative to the bandwidth of the broadband optical source;
receiving light from said at least one array of wavelength-specific devices following interaction with the array;
determining from said received light the signal characteristics associated with said interaction with the devices in said at least one array.

### BRIEF DESCRIPTION OF THE DRAWINGS

FIG. 1 is a schematic diagram of a first apparatus for interrogating wavelength-specific devices; and

FIG. 2 is a schematic diagram of a second apparatus for interrogating wavelength-specific devices.

### DETAILED DESCRIPTION OF PREFERRED EMBODIMENTS

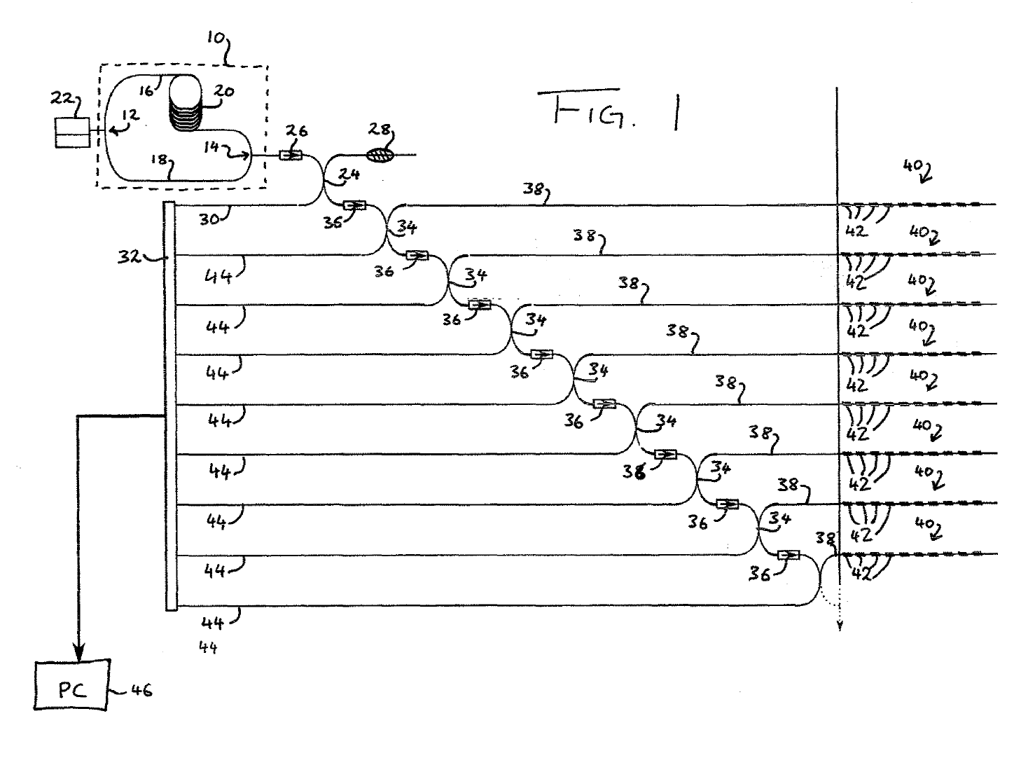

In FIG. 1, a fiber Mach-Zehnder interferometer 10 is shown having a pair of directional couplers 12,14 connected by a first fiber arm 16 and second fiber arm 18. In first fiber arm 16, a piezo-electric fiber stretcher 20 enables the length of arm 16 to be varied so as to change the interference pattern observed at directional coupler 14 at the output of the interferometer 10.

A broadband source 22 which is preferably a supercontinuum source as in this case, provides a broadband optical signal to the input of the interferometer 10 at directional coupler 12. The interferometer need not be of the type shown and can take the form of any temporally scanned interferometric configuration, whether fiber or bulk optic, capable of producing a low coherence temporal interferogram at the output.

At the output of the interferometer 10 the recombined light forms an interferogram, where the oscillating frequency is proportional to the wavelength of the light and would normally be seen as a low coherence interferogram by a detector which integrates over a range of frequencies.

This interferogram is then directed through an isolator 26 to prevent back-propagation and then via a directional coupler 24 to a thermally stabilised Bragg grating reference 28 (the function of which has been previously described) and a signal is returned via directional coupler 24 to an output fiber 30 which is received at a respective photodiode to convert from an optical to an electrical signal. Each photodiode output is fed to a respective port or channel of a multi-channel data acquisition board 32. Amplification may be provided along with simple optical-to-electrical conversion as required.

The directional coupler 24 is a 5/95 coupler meaning that 5% of the received input signal power is directed to the grating reference 28, while the remaining 95% is directed via isolator 36 to a cascaded series of directional couplers 34.

Each of the cascaded directional couplers 34 has an associated isolator 36 at its input to prevent back reflections towards the interferometer and the detection channel of the previous array. Each is, in this illustrated embodiment, a 5/95 coupler, directing 5% of its input power to a first arm 38 and 95% of its input power to the next isolator in the cascaded series. The splitter may be chosen to direct a different percentage of power in each direction, depending on arm length, source power etc. In this way, the low coherence interferogram produced by the interferometer 10 is successively divided and directed alone each of the arms 38 to a respective array 40 of devices 42.

Each of the devices 42 within a single array 40 is a wavelength-specific reflector/filter/transmitter, and in particular a fiber Bragg grating operating at a different wavelength (or band of wavelengths). Thus, a wideband optical signal directed into the array 40 from fiber 38 will undergo a series of reflections, with each device reflecting a narrow band of wavelengths back towards fiber arm 38. If the devices are located in different physical environments which cause variations in the characteristic reflection wavelength, then measurement of the returned spectrum of wavelengths allows each device's characteristic operating wavelength to be measured.

Reflections from the array travel back along fiber arm 38 to directional coupler 34 which directs 5% of the reflected signal along a respective output fiber 44 to the individual photodiode and then to a channel of the data acquisition board 32.

While each array should be composed of devices operating at unique wavelengths, each array may be identical or may share operating wavelengths with the other arrays. The limitation on only having a single device at each operating wavelength is thereby removed, since the interferogram can be fed into all of the arrays simultaneously, and since each array returns its own reflected signal based on the properties of its own devices.

The data acquisition board 32 (which may be for instance a National Instruments PCI-MIO-16E-4, capable of 500 kS/s or a PCI-6023E capable of 200 kS/s) samples and digitises each input channel and provides the resulting digital signal to a PC 46. PC 46 operates signal analysis software which performs a Fourier analysis on each channel's signal to determine the wavelength or frequency associated with each device in the array.

A Hilbert analysis may also be performed, preferably by the following steps in sequence:
1. Application of a windowing function, e.g. a Hamming window
2. Fourier transform
3. Removal of DC and negative frequencies
4. Inverse Fast Fourier Transform
5. Delay recalibration using interpolation
6. Fourier Transform
7. Sensor signal separation in frequency domain
8. Retrieval of analytical signal
9. Phase comparison

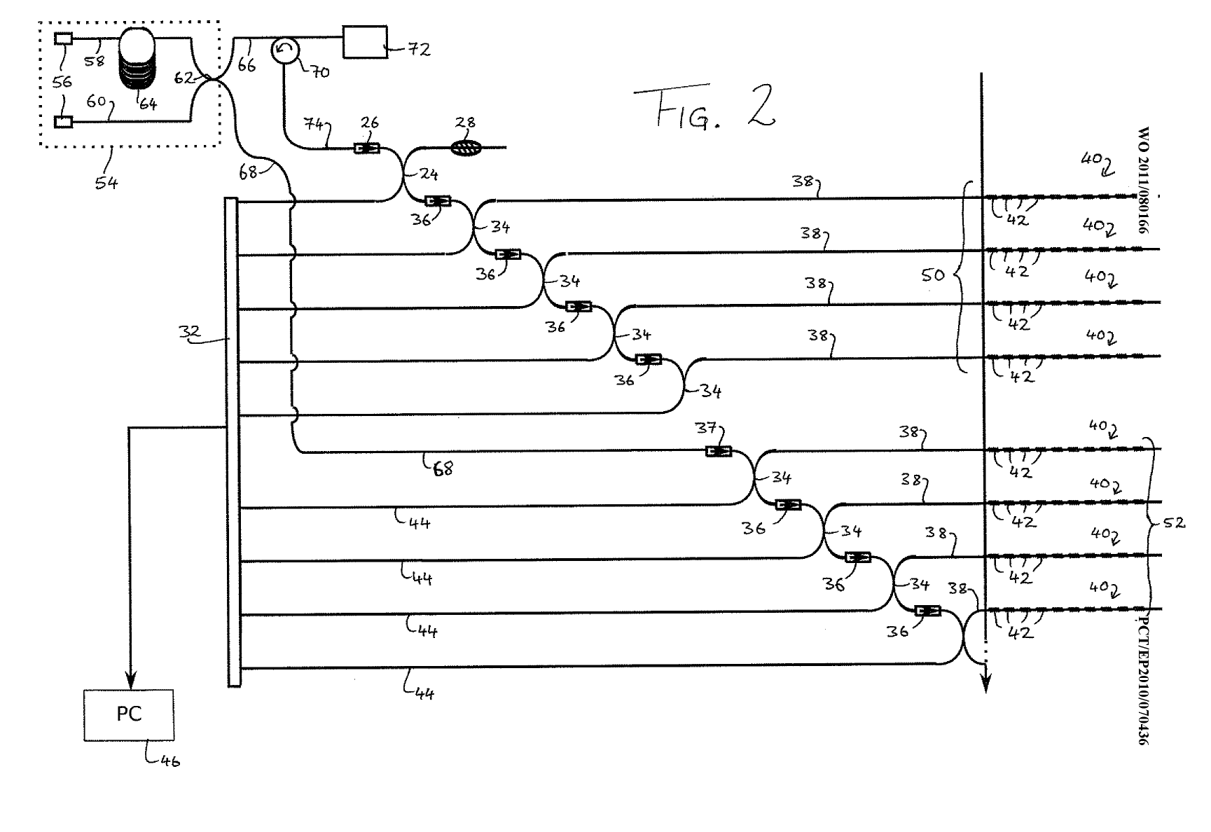

In FIG. 2, a second apparatus is shown which is similar in many respects to that of FIG. 1, and in which like reference numerals are employed for like components. Insofar as the systems are the same, the preceding description may be taken to also apply to FIG. 2.

Thus, the system employs similar arrays 40 of fiber Bragg gratings 42, each provided on a respective fiber arm 38, with reflected signals travelling along a respective output fiber 44 to a respective channel of a data acquisition board 32 connected to a PC 46.

Unlike in FIG. 1, the arrays 40 are provided in two cascaded groups, shown as a top group of four arrays 50 and a bottom group of four arrays 52, as described further below. The system of FIG. 2 differs from that of FIG. 1 primarily in terms of the illuminating interferometer arrangement.

Instead of a fiber Mach Zehnder interferometer, a fiber Michelson interferometer 54 is employed. The interferometer 54 is shown having a pair of Faraday rotation mirrors 56 connected by a first fiber arm 58 and second fiber arm 60 to a directional coupler 62. The Faraday rotation mirrors 56 reduce polarization-induced fading in the interferometer outputs.

In first fiber arm 58, a piezo-electric fiber stretcher 64 enables the length of arm 58 to be varied so as to change the interference pattern observed at the outputs 66,68 of directional coupler 62 at the output of the interferometer 54. An optical circulator 70 provides access to the interference pattern normally directed back towards a source 72 in a Michelson interferometer by directing this signal to fiber arm 74.

Broadband source 72 provides a broadband optical signal to the input of the interferometer 54 at directional coupler 62 via the optical circulator 70. At the outputs 68,74 of the interferometer arrangement the recombined light forms an interferogram, where the oscillating frequency is proportional to the wavelength of the light and would normally be seen as a low coherence interferogram by a detector which integrates over a range of frequencies.

This interferogram at output 74 is then directed through isolator 26 and then via a directional coupler 24 to a thermally stabilised Bragg grating reference 28 (the function of which has been previously described) and a signal is returned via directional coupler 24 to an output fiber 30 which is received at a respective photodiode to convert from an optical to an electrical signal as previously described.

The directional coupler 24 is again a 5/95 coupler meaning that 5% of the received input signal power is directed to the grating reference 28, while the remaining 95% is directed via isolator 36 to the first cascaded series 50 of directional couplers 34.

The interferogram at output 68 directs all of its power via isolator 37 to a second cascaded series 52 of directional couplers 34. In addition to providing a respective output interferogram via two outputs to two cascaded series of device arrays, the arrangement of FIG. 2 has the advantages that the Faraday rotation mirrors reduce polarization-induced fading and higher resolution is attainable from the delay scans as the delay is effectively multiplied by two with the double pass.

The invention is not limited to the embodiment(s) described herein but can be amended or modified without departing from the scope of the present invention.

1. An apparatus for interrogating wavelength-specific devices, the apparatus comprising:
a broadband optical source for providing a broadband light signal;
an interferometer for receiving said broadband light signal and for providing at an output thereof a low coherence temporal interferogram;
at least one array of wavelength-specific devices connected in series with one another for receiving said interferogram from said output, wherein each device interacts with a limited range of wavelength bandwidth relative to the bandwidth of the broadband optical source;
a detector for receiving light from said at least one array of wavelength-specific devices following interaction with the array;
a spectrum analyser adapted to determine from said received light the signal characteristics associated with said interaction with the devices in said at least one array.

2. An apparatus as claimed in claim 1, wherein a plurality of said arrays of wavelength-specific devices are provided, each array receiving the interferogram from said output in parallel, and a plurality of detectors being provided, such that the light from each array is directed to a different detector.

3. An apparatus as claimed in claim 1, wherein the devices are wavelength-specific reflectors connected in series, which each reflect a narrow band of wavelengths while allowing wavelengths outside this band to pass through.

4. An apparatus as claimed in claim 1, wherein the devices are wavelength-specific filters connected in series, which each intercept and filter out a first set of wavelengths while allowing wavelengths outside this set to pass through.

5. An apparatus as claimed in claim 1, wherein at least two of said arrays each contain a wavelength specific device which interact with light at the same wavelength.

6. An apparatus as claimed in claim 1, wherein the plurality of arrays are connected to said interferometer output by a series of couplers each of which transmits a first proportion of the received interferogram to an associated one of said arrays and transmits a second proportion of the received interferogram to a subsequent one of said couplers.

7. An apparatus as claimed in any claim 6, wherein the first proportion represents from 1 to 20% of the received power at the directional coupler, and the second proportion represents from 80 to 99% of the received power at the directional coupler.

8. An apparatus as claimed in claim 7, wherein the first proportion is from 2 to 10% and the second proportion is from 90 to 98%, more preferably, the first proportion is from 3 to 8% and the second proportion is from 92 to 97%, and most preferably the first proportion is about 5% and the second proportion is about 95.

9. An apparatus as claimed in claim 1, wherein a plurality of isolators is provided for preventing back-propagation of signals from the arrays towards the interferometer and the previous array's detection system.

10. An apparatus as claimed in claim 1, wherein a reference device is provided to receive and interact with said interferogram, said reference device being connected to a detector such that the interferogram may be calibrated by reference to the response of the reference device.

11. An apparatus as claimed in claim 1, wherein said spectrum analyser comprises a processor programmed to perform a mathematical analysis on the detected signal, said mathematical analysis preferably being a Fourier transform.

12. An apparatus as claimed in claim 1, wherein a plurality of said arrays of wavelength-specific devices are provided, the signal from each array being passed via a different channel to said spectrum analyser for signal analysis.

13. An apparatus as claimed in claim 11, wherein said spectrum analyser comprises the same or a different processor programmed to perform a Hilbert transform on the detected signal to calibrate for spectral content associated with temporal scanning of the interferometer.

14. An apparatus as claimed in claim 1, wherein each device within an array is responsive to light in a different range of wavelengths.

15. A method of interrogating wavelength-specific devices, comprising the steps of:
generating a low coherence temporal interferogram from an interferometer illuminated with a broadband optical source;
providing said interferogram to an input of at least one array of wavelength-specific devices connected in series with one another, wherein each device interacts with a limited range of wavelength bandwidth relative to the bandwidth of the broadband optical source;
receiving light from said at least one array of wavelength-specific devices following interaction with the array;
determining from said received light the signal characteristics associated with said interaction with the devices in said at least one array.
